(19) United States
(12) Patent Application Publication
(10) Pub. No.: US 2004/0264606 A1
(43) Pub. Date: Dec. 30, 2004

(54) Method and apparatus for demodulating block-code signals

(76) Inventors: Uriel Lemberger, Mitzpe Aviv (IL); Gal Basson, Haifa (IL); Nati Dinur, Omer (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/608,556

(22) Filed: Jun. 30, 2003

(51) Int. Cl. H04L 27/06

(52) U.S. Cl. 375/343; 375/350

(57) ABSTRACT

Embodiments of the present invention provide a method, apparatus and system for demodulating a received signal by selecting a demodulated codeword corresponding to a channel-influenced codeword based on a proximity relation between the received signal and the channel-influenced codeword.

### BACKGROUND OF THE INVENTION

According to IEEE802.11b standard, IEEE std. 802.11b-1999, a block-coded modulation method, e.g., a Complementary Code Keying (CCK) method, may be used for modulating. The CCK method includes using a pre-determined sub-set of 2^{P} codewords, wherein P is the number of bits per word. For example, for a transmission rate of 11 Mega bits per second (Mbps) using 8 bits per word, the sub-set may include 256 pre-determined codewords.

The block-coded modulation method may include using the sub-set of codewords to demodulate a received WLAN signal. According to this method, a set of correlators, each matched with a different one of the pre-determined codewords, may be used to calculate a correlation between the received signal and the respective codeword. The correlators may be associated with a selector adapted to select the codeword having the strongest correlation with the received signal.

The IEEE802.11 b standard defines an optimal transmission rate of about 11 Mbit/s and an ideal transmission range of a few hundred Feet. However, the actual transmission rate and/or transmission range achieved by devices known in the art may be much smaller, due to undesired noise and/or Inter-Symbol Interference (ISI).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified block-diagram illustration of an exemplary communication system in accordance with some exemplary embodiments of the present invention;

FIG. 2 is a simplified block-diagram illustration of a demodulator in accordance with some exemplary embodiments of the present invention;

FIG. 3 is a conceptual diagram depicting propagation of a signal in a multi-path channel according to exemplary embodiments of the invention;

FIG. 4 is a schematic illustration of a graph depicting sampled amplitudes of a channel impulse response as a function of time, according to exemplary embodiments of the invention;

FIG. 5 is a schematic illustration of a graph depicting amplitude components of a complex codeword transmission pattern as a function of time, according to an exemplary embodiment of the invention;

FIG. 6 is a schematic illustration of a graph depicting amplitude components of a channel response as a function of time, corresponding to individual components of the transmission pattern of FIG. 5 respectively, according to exemplary embodiments of the invention;

FIG. 7 is a schematic illustration of a graph depicting an amplitude component of a received complex signal as a function of time, according to an exemplary embodiment of the invention;

FIG. 8 is a schematic illustration of a matched demodulator according to some exemplary embodiments of the invention;

FIG. 9 is a schematic block diagram illustration of a matched demodulator in accordance with further exemplary embodiments of the invention; and

FIG. 10 is a schematic block diagram illustration of a matched demodulator in accordance with additional exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous-elements.

### DETAILED DESCRIPTION OF TIE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical; such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like. For example, “plurality of address generators” describes two or more address generators.

It should be understood that the present invention may be used in a variety of applications. Although the present invention is not limited in this respect, the circuits and techniques disclosed herein may be used in many apparatuses such as units of a wireless communication system, such as for example, a Wireless Local Area Network (WLAN) communication system and/or in any other unit and/or device that need a demodulator. Units of WLAN communication system intended to be included within the scope of the present invention include, by way of example only, mobile units (MU), access points (AP), wireless receivers, and the like.

Types of WLAN communication systems intended to be within the scope of the present invention include, although are not limited to, “IEEE-Std 802.11, 1999 Edition (ISO/IEC 8802-11: 1999)” standard, and more particularly in “EEEE-Std 802.11b-1999 Supplement to 802.11-1999,Wireless LAN MAC and PHY specifications: Higher speed Physical Layer (PHY) extension in the 2.4 GHz band” standard, “IEEE-Std 802.11g, Higher speed Physical Layer (PHY) extension to IEEE 802.11b” standard, and the like.

Although the scope of the present invention is not limited in this respect, the circuits and techniques disclosed herein may also be used in units of a cellular communication systems, digital communication systems, satellite communication systems and the like.

Types of cellular radiotelephone receivers intended to be within the scope of the present invention include, although not limited to, Code Division Multiple Access (CDMA), CDMA 2000 and wideband CDMA (WCDMA) cellular radiotelephone, receivers for receiving spread spectrum signals, and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a local area network (LAN), wide area network (WAN), or a global communication network, for example, the Internet.

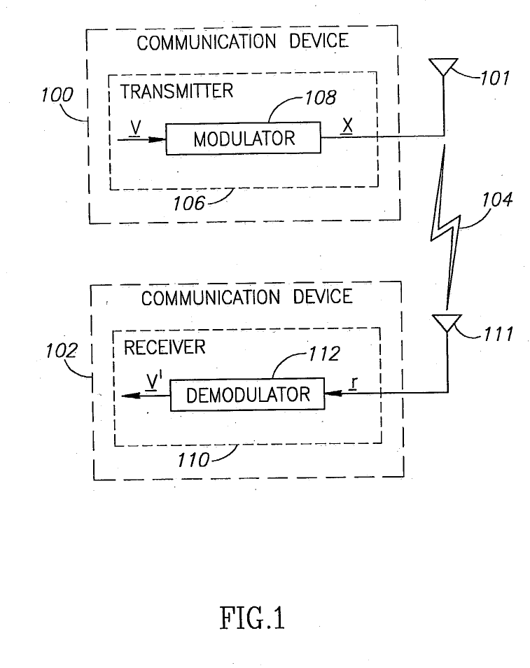

Reference is made to FIG. 1, which schematically illustrates an exemplary communication system in accordance with some embodiments of the present invention, enabling a first communication device 100 to communicate with a second communication device 102 over a communication channel 104.

Although the scope of the present invention is not limited in this respect, communication devices 100, 102 may comprise wire or wireless or cable modems of computers and communication channel 104 may be part of a wide-area-network (WAN) or a LAN. For example, the system may be a WLAN system or a digital subscriber line (DSL) system. In such cases, although the scope of the present invention is in no way limited in this respect, communication devices 100 and 102 may each comprise a radio frequency antenna, 101 and 111, respectively, as is known in the art. For example, the antennas may be omni-directional antennas, able to send and/or receive signals in a WLAN.

Communication device 100 may include a transmitter 106, which may include a modulator 108 in accordance with embodiments of the invention, as described in detail below. Communication device 102 may include a receiver 110, which may include a demodulator 112.

In some embodiments, receiver 110 and transmitter 106 may be implemented, for example, using separate and/or integrated units, for example, using a transmitter-receiver or transceiver.

As is known in the art, modulator 108 may modulate an input codeword (for example, a block or vector) v, based on a linear block code, to produce a modulated codeword, T_{mod}. Modulated codeword T_{mod} may be transmitted through communication channel 104, which may be a noisy channel, as is known in the art.

Receiver 110 may receive a word signal, r, from communication channel 104. Demodulator 112 may demodulate the received word to provide a demodulated codeword, as described below.

Methods according to some embodiments of the present invention may be implemented in demodulators using software, hardware or any suitable combination of software and/or hardware in accordance with specific implementations of embodiments of the invention.

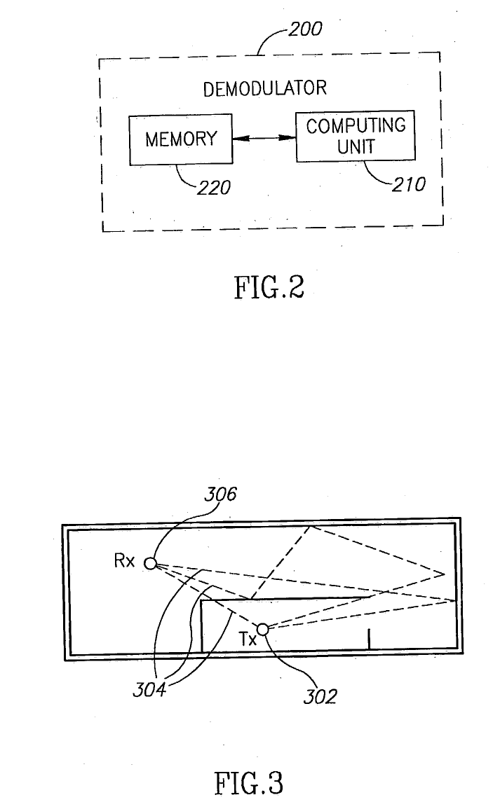

Reference is made to FIG. 2, which schematically illustrates a demodulator 200 in accordance with some exemplary embodiments of the present invention.

Demodulator 200 may include a computing unit 210 and a memory 220 coupled to computing unit 210. Although the scope of the present invention is not limited in this respect, computing unit 210 may include an application specific integrated circuit (ASIC), a reduced instruction set circuit (RISC), a digital signal processor (DSP) or a central processing unit (CPU). Instructions to enable computing unit to perform methods of embodiments of the present invention may be stored in memory 220.

According to exemplary embodiments of the invention, demodulator 200 may be used to calculate a proximity relation between received signal, A, and each one of a set of K possible codewords, Tᵢ. respectively, wherein i=1 . . . K, and wherein K may depend on a specified transmission rate, e.g., as defined by IEEE802.11b standard, IEEE std. 802.11b-1999. For example, the value of K may be 256 for a transmission rate of 11 Mega bit per second (Mbps). According to some of these embodiments, r and Tᵢ may each include a vector of N Quadrature Phase Shift Key (QPSK) symbols, respectively, e.g., according to the IEEE802.11b standard, N may equal 8 for the 5.5 Mbps and 11 Mbps transmission rates.

A timing parameter, e.g., a time delay, of the received signal may be provided by any suitable method known in the art, e.g., using a synchronization mechanism.

According to some embodiments of the invention, assuming the timing of the received signal is known, a proximity relation, C(r,Tᵢ), between r and each Tᵢ may be calculated. According to some of these embodiments, the proximity relation may be related to the Euclidian distance between r and Tᵢ, respectively, which may be calculated, for example, using the following equation:

C{r,T₁}≡|Tᵢ−r|² (1)

According to embodiments of the invention, demodulator 200 may also demodulate the received signal by selecting a demodulated codeword, T_{demod}, from the set of K codewords, such that T_{demod} may have a minimal Euclidian distance from the received signal compared to the Euclidian distance between the received signal and each one of the other K-1 possible codewords, respectively.

For example, demodulator 200 may select T_{demod}, so as to satisfy the following equation:

$$C \{ \underline{r} , {\underline{T}}_{demod} \} = {min}_{i} {\vert {\underline{T}}_{i} - \underline{r} \vert}^{2} \qquad ( 2 )$$

The right-hand side of Equation 2 may be rewritten as follows:

$$\begin{matrix}{min}_{i} {\vert {\underline{T}}_{i} - \underline{r} \vert}^{2} = {min}_{i} \{ ( {\underline{T}}_{i} - \underline{r} ) {( {\underline{T}}_{i} - \underline{r} )}^{*} \} \\ = {min}_{i} \{ {\vert {\underline{T}}_{i} \vert}^{2} + {\vert \underline{r} \vert}^{2} - {\underline{T}}_{i}^{*} \underline{r} - {\underline{r}}^{*} {\underline{T}}_{i} \}\end{matrix} \qquad ( 3 )$$

wherein:

$$\underline{r} \cdot {\underline{T}}_{i} ≡ {\sum }_{j = 1}^{N} \underline{r} ( j ) \cdot {\underline{T}}_{i} ( j ) \qquad ( 4 )$$

According to embodiments of the invention, the same index i that provides the minimum value for the right hand side of Equation 3, may also provide a maximum value of the following expression:

$$Re ( \underline{r} \cdot {\underline{T}}_{i}^{*} ) - \frac{{\vert {\underline{T}}_{i} \vert}^{2} + {\vert \underline{r} \vert}^{2}}{2} \qquad ( 5 )$$

Since r is independent of i, T_{demod} may be selected to satisfy the following equation, which may be derived by substituting Expression 5 in Equations 2 and 3:

$${T}_{de mod} = \{ {T}_{i} : {max}_{i} ( Re ( \underline{r} \cdot {\underline{T}}_{i}^{*} ) - \frac{{\vert {\underline{T}}_{i} \vert}^{2}}{2} ) \} \qquad ( 6 )$$

According to embodiments of the invention, demodulator 200 may implement Equation 6 to demodulate the received signal, and select T_{demod} satisfying Equation 6, such that the demodulated word may have a minimal Euclidian distance from the received signal, as described above.

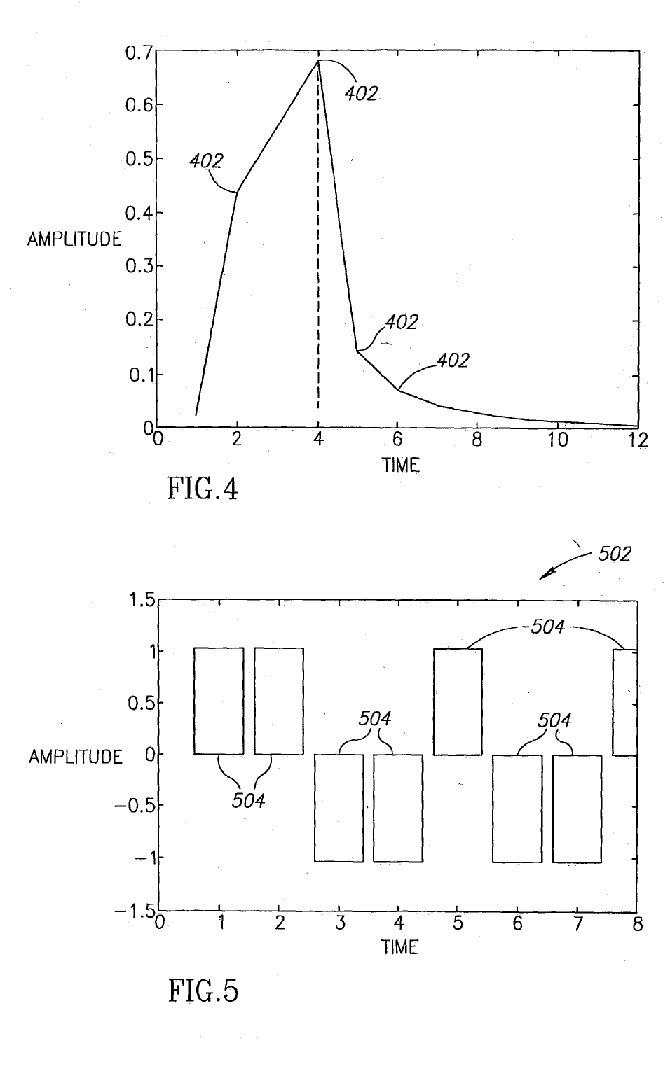

Reference is made to FIG. 3, which conceptually illustrates propagation of a signal transmitted by a transmitter 302 in a multi-path channel, according to exemplary embodiments of the invention, and to FIG. 4, which schematically illustrates a graph depicting sampled amplitudes of a channel impulse response as a function of time, according to exemplary embodiments of the invention.

As shown in FIG. 3, a signal transmitted by transmitter 302 may propagate through several different paths 304 before being received by a receiver 306. Different paths 304 may be created by different reflections in a communication channel between the transmitter and the receiver. Thus, receiver 306 may receive a signal, having different power levels, e.g., different amnplitudes, and/or different phases. The received signal may include the reflections of the transmitted signal and may also include different undesired forms of noise and/or deformations, as is known in the art. A channel impulse response, e.g., as shown in FIG. 4, may be defined by the sampled amplitudes 402 received by receiver 306 corresponding to an impulse signal transmitted by transmitter 302.

Reference is made to FIG. 5, which schematically illustrates a graph depicting amplitude components of a complex codeword transmission pattern as a function of time, according to an exemplary embodiment of the invention;

As shown in FIG. 5, codeword transmission pattern 502 may include eight QPSK symbols 504 which may have a binary representation, for example, the binary representation [1,1,-1,-1,1,-1,-1,1], and may be transmitted in a time period corresponding to the length of the eight QPSK symbols.

According to exemplary embodiments of the invention, the codeword of FIG. 5 may propagate through a channel having the channel impulse response depicted in FIG. 4.

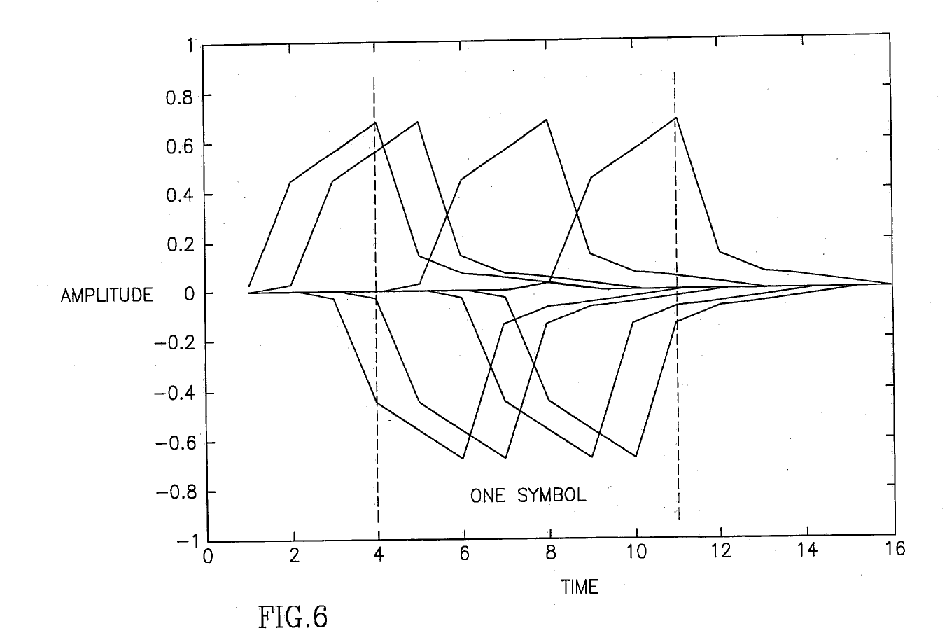

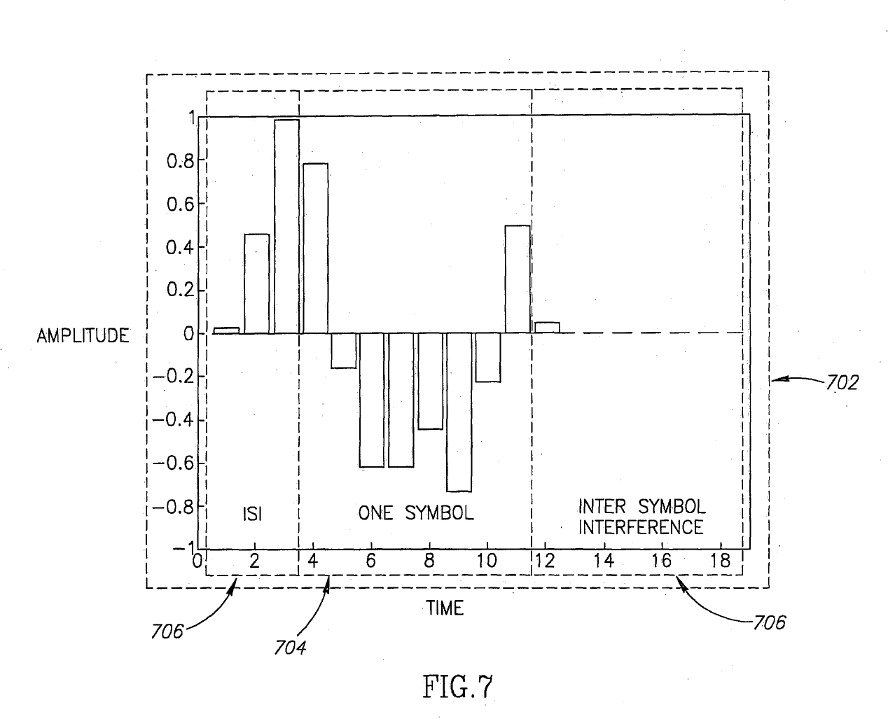

Reference is made to FIG. 6, which schematically illustrates a graph depicting amplitude components of a channel response as a function of time, corresponding to individual components of the transmission pattern of FIG. 5 respectively, and to FIG. 7, which schematically illustrates a graph depicting an amplitude component of a received complex signal 702 as a function of time, according to some exemplary embodiments of the invention.

According to exemplary embodiments of the invention, signal 702 may include the transmitted signal of transmitter 302 (FIG. 3) as received by receiver 306 (FIG. 3), after passing through the channel of FIG. 4.

As shown in FIG. 7, signal 702 may be received in a time period corresponding to the length of more than eight QPSK symbols. Since the demodulator may sample a codeword 704 including eight QPSK symbols, signal 702 may affect more than one codeword sampled by the demodulator. Thus, signal 702 may include sampled codeword 704 and two Inter Symbol Interference (ISI) signals 706 affecting adjacent codewords, respectively.

As shown in FIG. 7, if demodulator 200 (FIG. 2) is to be used to demodulate codeword 704, as described above, the demodulated codeword may have the binary representation [1,-1,-1,-1,-1,-1,-1,1], which may be substantially different from the transmitted codeword of FIG. 5.

According to embodiments of the invention, this error may be related to the channel response, which may introduce interference, also referred to as Inter Chip Interference (ICI), between the transmitted QPSK symbols, as described above.

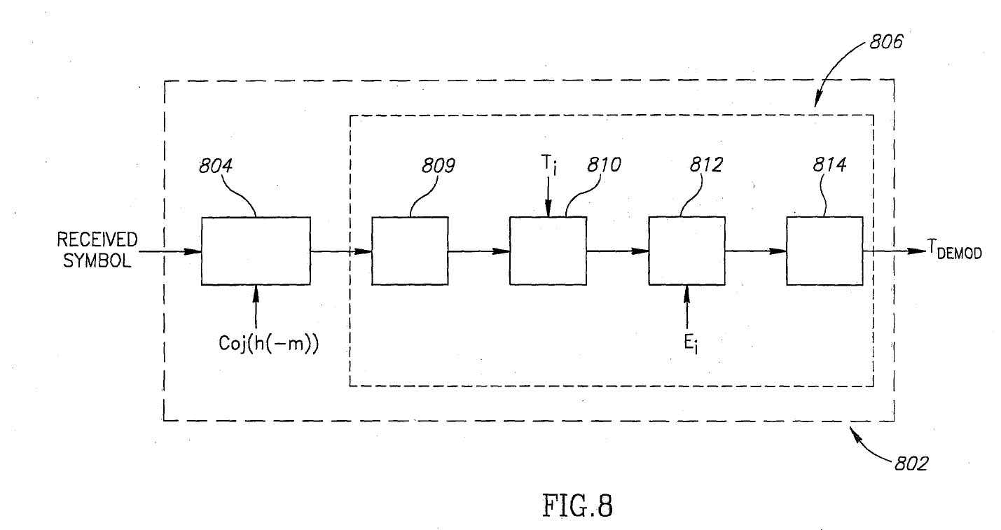

Reference is made to FIG. 8, which schematically illustrates a matched demodulator 802, also referred to as a matched correlator, according to exemplary embodiments of the invention.

According to embodiments of the invention, demodulator 802 may calculate a proximity relation between the received signal and a set of K channel-influenced codewords to substantially eliminate the effect of the ICI, as described below.

According to embodiments of the invention, demodulator 802 may include an intermittent filter, e.g., an intermittent Finite Impulse Response (FIR) match filter 804, associated with a decoder, e.g., a modified Fast Walsh Transform (FWT) decoder 806.

According to embodiments of the invention, filter 804 may be used to individually sample each received codeword, which may include N, for example, eight, QPSK symbols, of the received signal. This may be accomplished, for example, by resetting filter 804 after each received codeword, according to a known timing of the received signal. According to Nyquist's Theorem, as is known in the art, in order to minimize loss of information when sampling a signal, the signal may be sampled at a sampling rate equal to at least twice the signal bandwidth. For example, to comply with the Nyquist Theorem for a transmission rate of 11 Mbps having an effective bandwidth of 11 MHz, according to some exemplary embodiments of the invention, filter 804 may have a sampling rate of about 22 Mbps or higher. Thus, according to these exemplary embodiments, each received codeword may be sampled by filter 804 sixteen times. Filter 804 may provide a correlation between each sampled codeword and a sampled channel response, respectively, as described below.

According to exemplary embodiments of the invention, decoder 806 may include a decimator 809, a correlator 810, an energy subtractor 812 and a maximum selector 814. Decimator 809 may include any suitable decimator, as is known in the art, to reduce the signal rate by a decimation factor, e.g., a factor of two, as described below. Correlator 810 may compute a set of correlation values, each corresponding to a correlation between a correlator input signal and each of the Tᵢ codewords, respectively. For example, correlator 810 may include a FWT correlator or a set of sub-correlators as is known in the art. Subtractor 812 may subtract an energy related function from each one of the correlation values to respectively provide a set of modified correlation values. For example, subtractor 812 may include any subtractor as is known in the art. Maximum selector 814 may include any selector, as is known in the art, to select a maximum value of the modified correlation values.

According to some embodiments of the invention, Equation 1 may be implemented for calculating a proximity relation, e.g., a Euclidian distance, between the received signal, r, and each of a set of K channel-influenced codewords, Tᵢ*h, wherein h is the channel impulse response, and wherein the channel-influenced codewords may be defined by a convolution of h over Tᵢ. It will be appreciated by a person skilled in the art that other suitable definitions of the channel-influenced codeword are also included within the scope of the invention.

According to exemplary embodiments of the invention, demodulator 802 may calculate h based on the channel response to a test transmission including a pre-defined test codeword, as is known in the art.

Thus, substituting Tᵢ with Tᵢ*h in Equation 1, may yield the following equation:

C{r,Tᵢ*h}≡|(Tᵢ*h)−r|² (7)

According to embodiments of the invention, demodulator 802 may demodulate the received signal by selecting a demodulated codeword, T_{demod1}, from the set of K possible codewords based on a proximity relation between the received signal and the channel-influenced codeword. For example, T_{demod1}, may be selected such that the channel-influenced demodulated codeword, T_{demod1}*h, may have a mininum Euclidian distance from the received signal compared to the Euclidian distance between the received signal and each one of the other i-1 possible channel-influenced codewords, respectively, as described above.

Thus, demodulator 802 may select values for T_{demod1} that satisfy the following equation, which may be derived by substituting T with T*h in Equation 6 above:

$${T}_{de mod1} = \{ {T}_{i} : {max}_{i} ( Re ( r \cdot {( {\underline{T}}_{i} * \underline{h} )}^{*} ) - \frac{{\vert {\underline{T}}_{i} * \underline{h} \vert}^{2}}{2} ) \} \qquad ( 8 )$$

According to exemplary embodiments of the invention, each of the received codewords may be sampled by filter 804, e.g., sixteen times, and may include 2N, e.g. sixteen, samples of the N, e.g., eight QPSK symbols, denoted r(m), as described above. Thus, Equation 8 may be rewritten as follows:

$${T}_{de mod1} = \{ {T}_{i} : {max}_{i} ( Re ( {\sum }_{m = 0}^{15} ( r ( m ) \cdot {( {\underline{T}}_{i} * \underline{h} )}^{*} ( m ) ) ) - \frac{{\vert {\underline{T}}_{i} * \underline{h} \vert}^{2}}{2} ) \} \qquad ( 9 )$$

wherein h(m) are channel input response samples corresponding to each of the samples; respectively. The channel response samples may be provided by a channel estimator, as is known in the art.

The expression in the right-hand side of Equation 9 may be rewritten as follows:

$$\{ Re ( {\sum }_{m = 0}^{15} ( r ( m ) \cdot {( {\underline{T}}_{i} * \underline{h} )}^{*} ( m ) ) ) - \frac{{\vert {\underline{T}}_{i} * \underline{h} \vert}^{2}}{2} \} = \{ Re ( {\sum }_{m = 0}^{15} ( r ( m ) \cdot {\sum }_{m = 0}^{15} ( {\underline{T}}_{i}^{*} ( j ) \cdot {h}^{*} ( m - j ) ) ) ) - \frac{{\vert {\underline{T}}_{i} * \underline{h} \vert}^{2}}{2} \} = ( Re ( {\sum }_{j = 0}^{15} ( {\underline{T}}_{i}^{*} ( j ) \cdot {\sum }_{m = 0}^{15} ( r ( m ) \cdot {h}^{*} ( m - j ) ) ) ) - \frac{{\vert {\underline{T}}_{i} * \underline{h} \vert}^{2}}{2} \} \qquad ( 10 )$$

Substituting Expression 10 into Equation 9 may yield the following equation:

$${T}_{de mod1} = \{ {T}_{i} : {max}_{i} ( Re ( {\sum }_{j = 0}^{15} ( {\underline{T}}_{i}^{*} ( j ) \cdot {\sum }_{m = 0}^{15} ( r ( m ) \cdot {h}^{*} ( m - j ) ) ) ) - \frac{{\vert {\underline{T}}_{i} * \underline{h} \vert}^{2}}{2} ) \} \qquad ( 11 )$$

According to embodiments of the invention, filter 804 may receive inputs of h(m) and r(m), as desired. Filter 804 may provide an output signal, S_{filter}(j) corresponding to the sampled codeword, such that:

$${S}_{filter} ( j ) = {\sum }_{m = 0}^{15} ( r ( m ) \cdot {h}^{*} ( m - j ) ) \qquad ( 12 )$$

Thus, filter 804 may calculate a correlation between the sampled codeword containing the r(m) samples, and a sampled channel response containing the channel response samples h(m). The correlation may be calculated over pairs of respective samples r(m) and h(m).

According to some exemplary embodiments of the invention, decimator 809 may have a decimation factor of two, such that a signal, S₁, including only N, e.g. eight, of the filter output symbols may enter correlator 810. These eight symbols may correspond to the eight QPSK symbols of the codeword, which may be sampled by filter 804 sixteen times.

Thus, substituting Equation 12 in Equation 11 may yield the following equation:

$${T}_{de mod1} = \{ {T}_{i} : {max}_{i} ( Re ( {\sum }_{j = 0}^{7} ( {\underline{T}}_{i}^{*} ( j ) \cdot {S}_{1} ( j ) ) ) - {\underline{E}}_{i} ) \} \qquad ( 13 )$$

wherein Ei is an energy related function of the channel-influenced codeword, Tᵢ*h, defined as follows:

$$\begin{matrix}{\underline{E}}_{i} ≡ \frac{{\vert {\underline{T}}_{i} * \underline{h} \vert}^{2}}{2} & \end{matrix} \qquad ( 14 )$$

According to exemplary embodiments of the invention, decoder 806 may have three inputs, which may include S₁(j), Eᵢ, and Tᵢ, respectively, if desired.

According to embodiments of the invention correlator 810 may have two inputs, which may include a filtered signal containing symbols, e.g. eight symbols, of S₁(j), and K possible codewords, Tᵢ, respectively, if desired. Correlator 810 may provide k, e.g. k=256, outputs, denoted O_{corr(i)}, corresponding to the possible codewords, Tᵢ, respectively. The values of O_{corr} may be calculated using the following equation:

$${O}_{corr ( i )} = Re ( {\sum }_{j = 0}^{7} ( {\underline{T}}_{i}^{*} ( j ) \cdot {S}_{1} ( j ) ) ) \qquad ( 15 )$$

According to embodiments of the invention, subtractor 812 may receive an input of the K O_{corr(i)} and Eᵢ values, respectively. Subtractor 812 may provide the K outputs, Q_{sub(i)}, which may be calculated using the following equation:

O_{sub(i)}=Q_{corr(i)}−Eᵢ (16)

According to embodiments of the invention, selector 814 may select T_{demod1} according to the following equation, which may be equivalent to Equation 13:

$${T}_{demod1} = \{ {T}_{1} : {max}_{i} ( {O}_{sub ( i )} ) \} \qquad ( 17 )$$

Thus, according to these embodiments, decoder 806 may select a demodulated codeword, T_{demod1}, out of the code-word set of K possible codewords, Tᵢ based on the filtered signal and the energy-related function, Eᵢ, in accordance with Equation 13.

According to embodiments of the invention, the ISI caused by signals 706 (FIG. 7) may affect each sampled codeword as described above. According to embodiments of the invention, a Decision Feedback Equalizer (DFE) may be implemented, to substantially eliminate the ISI, as described below.

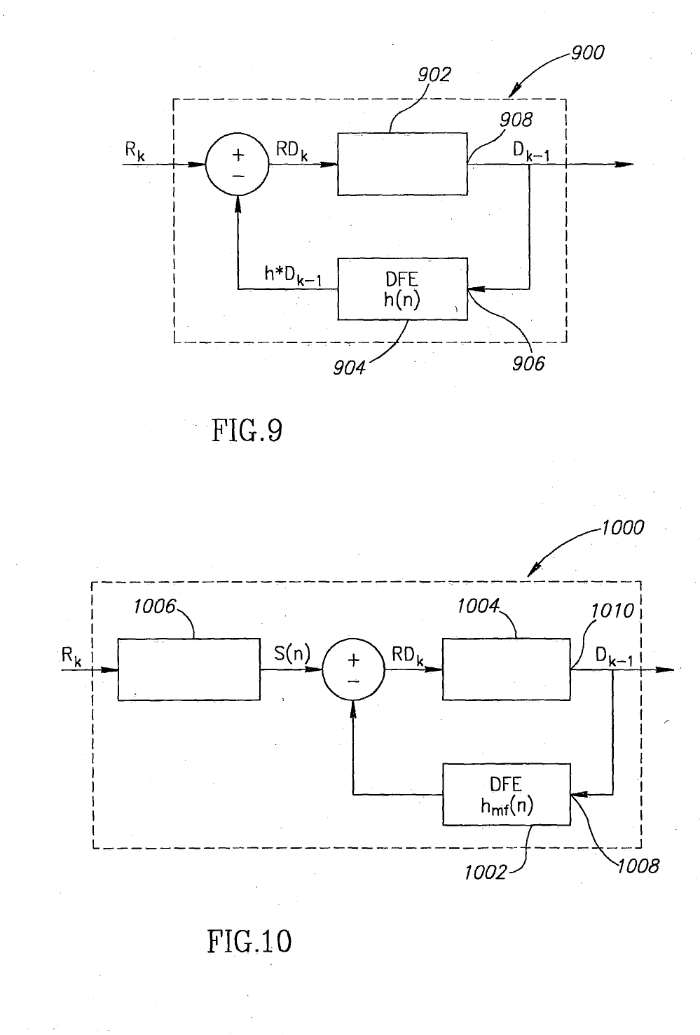

Reference is made to FIG. 9, which schematically illustrates a matched demodulator 900 in accordance with additional exemplary embodiments of the invention.

According to exemplary embodiments of the invention, demodulator 900 may receive an input signal, Rₖ, including a set of received codewords, rₖ. Demodulator 900 may include a matched demodulator 902, which may be substantially similar to matched demodulator 800 as described above with reference to FIG. 8, if desired. Demodulator 900 may also include a DFE 904 having a DFE input 906 associated with a demodulator output 908 of demodulator 902.

According to embodiments of the invention, demodulator 900 may be adapted to use a demodulated word, Dₖ₋₁, which may be demodulated by demodulator 902, to calculate the influence of the ISI, denoted ISI_{Dk-1}, of word Dₖ₋₁ on a subsequent input codeword of signal Rₖ. According to these embodiments, DFE 904 may calculate ISI_{Dk-1}, e.g., using the following equation:

ISI_{Dk-1}=h(m)* Dₖ₋₁ (18)

According to these embodiments of the invention, a demodulator input codeword, RD0ₖ, entering demodulator 902 may be calculated according to the following equation:

RD0ₖ=rₖ−|h(m)* D_{k-1|current demodulated word} (19)

Reference is made to FIG. 10, which schematically illustrates a matched demodulator 1000 in accordance with further exemplary embodiments of the invention.

According some exemplary embodiments of the invention, demodulator 1000 may receive an input signal, Rₖ, including a set of received codewords, rₖ. Demodulator 1000 may include an intermittent matched filter 1006, which may be similar to matched filter 804 as described above with reference to FIG. 8, if desired. Demodulator 1000 may further include a modified FWT decoder 1004, which may be similar to decoder 806 as described above with reference to FIG. 8, if desired. Demodulator 1000 may also include a DFE 1002 having a DFE input 1008 associated with an output 1010 of decoder 1004. Filter 1006 may have an output signal, denoted S_{filter(j)}, corresponding to each sampled QPSK symbol of each codeword, rₖ, respectively, as described above.

According to embodiments of the invention, demodulator 1000 may be adapted to use a decoded word, Dₖ₋₁, decoded by decoder 1004, to calculate the influence of the ISI, denoted ISI_{Dk-1}, of word Dₖ₋₁ on a subsequent, filtered, input codeword at the output of filter 1006. According to these embodiments, DFE 1003 may calculate ISI_{Dk-1}, e.g., using the following equation:

ISI_{Dk-1}=h_{mf}(n)* Dₖ₋₁ (20)

wherein, for example, n=1, . . . N, and wherein h_{mf}(n) is the DFE impulse response, as described below.

Since DFE 1002 may be adapted to calculate the ISI influence on a filtered codeword, the DFE impulse response may be calculated using the following equation:

$${h}_{mf} ( n ) = {\sum }_{m = 0}^{15} h ( m ) h ( m - n ) \qquad ( 21 )$$

According to these embodiments of the invention, a filtered signal denoted RD1ₖ entering decoder 1004 may include a combination of the influence of the ISI and the output of the filter. For example, RDₖ may be calculated according to the following equation:

$${\underline{RD1}}_{k} = {\sum }_{n = 0}^{7} \underline{S} ( n ) - {[ {h}_{mf} ( n ) * {\underline{D}}_{k - 1} ]}_{current demodulated word} \qquad ( 22 )$$

It may be obvious to those skilled in the art that demodulators according to exemplary embodiments of the invention, as described above, may accommodate environments with other undesired forms of noise, for example, white Gausian noise.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. An apparatus comprising:
a demodulator to demodulate a received signal by selecting a demodulated codeword corresponding to a channel-influenced codeword based on a proximity relation between said received signal and said channel-influenced codeword.

2. The apparatus of claim 1 wherein said demodulator is able to determine said proximity relation by calculating a minimal Euclidian distance between said received signal and said channel-influenced codeword.

3. The apparatus of claim 1 comprising an intermittent filter to individually sample a received codeword containing sampled symbols of said received signal, and to calculate a correlation between said received codeword and a sampled channel response containing channel response samples.

4. The apparatus of claim 3 wherein said filter comprises a finite impulse response matched filter.

5. The apparatus of claim 1 comprising a decoder to select said demodulated codeword out of a set of possible codewords, based on a filtered signal and an energy-related function of said channel-influenced codeword.

6. The apparatus of claim 5 comprising:
a decision feedback equalizer to calculate an inter symbol interference of said demodulated codeword; and
an intermittent filter to individually sample a received codeword containing sampled symbols of said received signal, and to calculate a correlation between said received codeword and a sampled channel response containing channel response samples,
wherein said filtered signal comprises a combination of said interference and an output of said filter.

7. The apparatus of claim 5 wherein said decoder comprises a fast walsh transform correlator.

8. The apparatus of claim 1 wherein said channel-influenced codeword comprises a convolution of a channel response over a respective codeword.

9. A system comprising:
a first communication device to transmit a signal through a communication channel; and
a second communication device able to receive said signal, said second device comprises a demodulator to demodulate a received signal by selecting a demodulated codeword corresponding to a channel-influenced codeword based on a proximity relation between said received signal and said channel-influenced codeword.

10. The system of claim 9 wherein said demodulator is able to determine said proximity relation by calculating a minimal Euclidian distance between said received signal and said channel-influenced codeword.

11. The system of claim 9 wherein said second device comprises an intermittent filter to individually sample a received codeword containing sampled symbols of said received signal, and to calculate a correlation between said received codeword and a sampled channel response containing channel response samples.

12. The system of claim 11 wherein said filter comprises a finite impulse response matched filter.

13. The system of claim 9 wherein said second device comprises a decoder to select said demodulated codeword out of a set of possible codewords, based on a filtered signal and an energy-related function of said channel-influenced codeword.

14. The system of claim 13 wherein said second device comprises:
a decision feedback equalizer to calculate an inter symbol interference of said demodulated codeword; and
an intermittent filter to individually sample a received codeword containing sampled symbols of said received signal, and to calculate a correlation between said received codeword and a sampled channel response containing channel response samples,
wherein said filtered signal comprises a combination of said interference and an output of said filter.

15. The system of claim 13 wherein said decoder comprises a fast walsh transform correlator.

16. The system of claim 9 wherein said channel-influenced codeword comprises a convolution of a channel response over a respective codeword.

17. A wireless communications device comprising:
An omni-directional antenna able to send and receive signals;
a demodulator to demodulate a received signal by selecting a demodulated codeword corresponding to a channel-influenced codeword based on a proximity relation between said received signal and said channel-influenced codeword.

18. The wireless communications device of claim 17 wherein said demodulator is able to determine said proximity relation by calculating a minimal Euclidian distance between said received signal and said channel-influenced codeword.

19. The wireless communications device of claim 17 comprising an intermittent filter to individually sample a received codeword containing sampled symbols of said received signal, and to calculate a correlation between said received codeword and a sampled channel response containing channel response samples.

20. The wireless communications device of claim 17 wherein said filter comprises a finite impulse response matched filter.

21. The wireless communications device of claim 17 comprising a decoder to select said demodulated codeword out of a set of possible codewords, based on a filtered signal and an energy-related function of said channel-influenced codeword.

22. The wireless communications device of claim 21 comprising:
a decision feedback equalizer to calculate an inter symbol interference of said demodulated codeword; and
an intermittent filter to individually sample a received codeword containing sampled symbols of said received signal, and to calculate a correlation between said received codeword and a sampled channel response containing channel response samples,
wherein said filtered signal comprises a combination of said interference and an output of said filter.

23. The wireless communications device of claim 21 wherein said decoder comprises a fast walsh transform correlator.

24. The wireless communications device of claim 17 wherein said channel-influenced codeword comprises a convolution of a channel response over a respective codeword.

25. A method comprising:
selecting a demodulated codeword corresponding to a channel-influenced codeword based on a proximity relation between a received signal and said channel-influenced codeword.

26. The method of claim 25 wherein said channel-influenced codeword comprises a convolution of a channel response over a respective codeword.

27. The method of claim 25 comprising calculating a minimal Euclidian distance between said received signal and said channel-influenced codeword to determine said proximity relation.

28. An article comprising a storage medium having stored thereon instructions that, when executed by a processing platform, result in:
selecting a demodulated codeword corresponding to a channel-influenced codeword based on a proximity relation between a received signal and said channel-influenced codeword.

29. The article of claim 28 wherein said channel-influenced codeword comprises a convolution of a channel response over a respective codeword.

30. The article of claim 28 wherein said instructions result in calculating a minimal Euclidian distance between said received signal and said channel-influenced codeword to determine said proximity relation.

31. A demodulator comprising:
an intermittent filter to individually sample a received codeword containing sampled symbols of a received signal, and to calculate a correlation between said received codeword and a sampled channel response containing channel response samples;
a correlator to compute one or more correlation values, corresponding to a correlation between a filtered signal and one or more respective codewords;
a subtractor to subtract an energy-related function from an output of said correlator; and
a selector to select a demodulated codeword corresponding to a maximum value output of said subtractor.

32. The demodulator of claim 31 wherein said filtered signal comprises symbols contained in an output of said filter

33. The demodulator of claim 31 comprising a decision feedback equalizer to calculate an inter symbol interference of said demodulated codeword, wherein said filtered signal comprises a combination of said interference and symbols contained in an output of said filter.

34. The demodulator of claim 31 wherein said intermittent filter comprises a finite impulse response matched filter.

35. The demodulator of claim 31 wherein said correlator comprises a fast walsh transform correlator.
